(19) United States
(12) Patent Application Publication
(10) Pub. No.: US 2006/0060539 A1
(43) Pub. Date: Mar. 23, 2006

(54) Method for treating at ambient temperatures acid or non-acid mine drainage waters containing heavy metals using recirculated iron oxide as an oxidation and precipitation catalyst

(76) Inventor: Bob G. Anthony, Brookhaven, MS (US)

Correspondence Address: Ruth Schiermeyer, 6034 75th Street, Lubbock, TX, 79424, US

(21) Appl. No.: 10/944,346

(22) Filed: Sep. 20, 2004

(51) Int. Cl. C02F 1/52

(52) U.S. Cl. 210/722

(57) ABSTRACT

The present invention is to provide a method for treating Acid Mine Drainage (AMD) or Non-Acid Mine Drainage (NAMD) waters, exhibiting a relative acidity/alkalinity pH factor of from 5.0 to 10.0, containing one or more of the heavy metals Fe, Mn, Mg, Al, Cu, Ni, Cr, or Zn held in solution, the method including: recovery and recirculation of existing iron oxide sediment and/or sludge precipitated in an AMD/NAMD water treatment settlement pond, basin or tank to blend with AMD/NAMD water containing heavy metals in solution, mixing the iron oxide sediment/sludge as a catalyst into and blending with AMD and NAMD water containing heavy metals in solution to accelerate the oxidation and sedimentation process of the heavy metals as precipitated heavy metal oxides and hydroxides in the AMD/NAMD water being treated.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field Endeavor

This invention relates generally to the addition of a system for supplementation to acid mine or non-acid mine drainage water treatment systems, treating water containing excessive amounts of heavy metals found in solution and, more particularly, to an apparatus and method for supplementing the treatment of acid mine or non-acid mine drainage waters containing heavy metals, by recovery and recirculation of existing iron oxide and/or iron oxide sludge found in a settlement pond, basin or tank, which acts as a catalyst in accelerating the oxidation and precipitation of the heavy metals found in solution, particularly iron.

2. Description of Information Known to Me

Acid mine drainage (AMD) and non-acid mine (NAMD) water results from the exposure and subsequent oxidation and dissolution of metallic minerals, primarily pyrite, during the mining of coal and various metal ores. The metallic products are dissolved by infiltrating rainwater and snow melt, eventually emerging in acid/non-acid seeps or springs.

Heavy metal contaminated mine drainage is a common consequence of mining. In the United States alone, it has been estimated that in excess of one billion pounds per year of iron is discharged from active and abandoned mines. In the United States, millions of dollars per day are spent treating the heavy metal content drainage from active and abandoned mine sites. At thousands of sites, particularly in the Appalachian coal mining areas where responsible parties do not exist, the contaminated water flows untreated into receiving streams. An estimated 6,000 miles of streams, rivers and bays are polluted with excessive concentrations of heavy metals from untreated mine drainage in Appalachia alone.

Two types of systems have become accepted in the industry as conventional means for treating AMD and NAMD systems, designated as Passive and Active. Passive systems are generally used when AMD or NAMD flows are less than 500 gallons per minute. These systems use relatively large surface area settlement ponds for atmospheric oxidation of the heavy metals found in solution and are constructed in such a manner that use of biological habitat is incorporated to effect precipitation of the heavy medals. These systems, once constructed, require no mechanical equipment for daily operations and have minimal costs for maintenance and supervisory operations. For AMD flows, limestone bedded drains may be required to increase pH to a neutral state. For AMD and NAMD flows, normally the only maintenance required is physical removal of the heavy metal precipitate sludge upon settlement ponds being filled.

Active AMD or NAMD treatment processes are normally used for flows of in excess of 500 gallons per minute. Treatment systems basically comprise four stages: (1) neutralization (if necessary), (2) aeration, (3) settling and (4) disposal of sludge. Capital and operating costs for treatment are high. Preparation for each stage requires special construction of site and installation of equipment. Neutralization usually requires frequent addition of highly alkaline materials to the AMD and also requires equipment for the storage and application of the neutralizing material. Neutralization is not required for NAMD water. Aeration generally requires excavation for an aeration basin and installation of air compressors with nozzles or mechanical devices placed in the aeration basin. Settling requires excavation of two or more relatively large surface area settling ponds of sufficient size to allow sufficient time for the oxidized metals to precipitate through the force of gravity. Once one settlement pond becomes filled with sediment, the treated AMD water is transferred to the other, and the first pond is deactivated and allowed to atmospherically dry. The resulting sludge, commonly containing ferric hydroxide, ferrous hydroxide, manganese oxide and aluminum hydroxide, is generally disposed of by excavation of the dried sediment in the deactivated pond, loading onto trucks and transport to an approved disposal area. In some cases the wet sludge can be pumped to a deep abandoned mine, If available, and injected. Typical capital costs for AMD treating facilities with stream flows in excess of 500 GPM range between about $1 and $2 million with annual operating costs ranging from $100,000 to $200,000.

A discussion of commonly used, conventional processes can be found in a publication of the Environmental Protection Agency entitled “Design Manual: Neutralization of Acid Mine Drainage” (EPA-600/2-83-001, January 1983) and a publication used for the estimated cost projections for treatment of AMD/NAMD can be found in “Methodology for Estimating the Costs of Treatment of Mine Drainage” prepared for U.S. Office of Surface Mining, Pittsburgh, Pa. 15222, February, 2000.

The keys to successful Active AMD or NAMD treatment are sufficient alkalinity and aeration to promote oxidation of heavy metals found in solution and sedimentation of the resulting metal oxides/hydroxides. If the pH of AMD water is less than 5.0, the rate of oxidation of most heavy metals found in solution and consequently, the rate of sedimentation of metal oxides/hydroxides, is prohibitively slow and the oxidation and sedimentation of magnesium is basically nonexistent. Increase in pH may be of necessity and can be obtained by the costly addition of an alkaline material to the AMD water. Iron dissolved in the acidic water is often in the ferrous Fe(2+) state and must be oxidized to the ferric state Fe(3+) so that it will hydrolyze and precipitate as iron hydroxide Fe(OH).sub.3 and iron oxides, Fe.sub.2O.sub.3 and Fe.sub.3O.sub.4. The rate of the oxidation is a function of the dissolved oxygen and pH, and acid mine water contains only relatively small amounts of dissolved oxygen. Aeration requirements vary, based upon iron concentrations and flow volume, but it is generally known that 8 milligrams per liter of dissolved oxygen must be present in the AMD or NAMD water being treated for efficient oxidation of heavy metals. In Passive treatment systems, to replenish the dissolved oxygen, conventional settling ponds are made with relatively large surface areas to maximize the diffusion of oxygen into the water. In some situations increase in dissolved oxygen may be necessitated by incorporating a series of drops (water falls) in the flow path of the water, prior to entering the settlement ponds, in order to produce turbulence and increase the concentration of dissolved oxygen. Required surface area of settlement ponds at many sites is so large that it is cost prohibitive. In these situations, an Active system must be utilized with supplementary aeration sources. Often the addition of alkaline materials to AMD water is utilized to increase the pH and the addition of chemical flocculants to AMD or NAMD water is utilized to accelerate precipitation of the heavy metals. Air compressors and/or mechanical aerators are frequently used to aerate the AMD or NAMD water. Disadvantages for these methods include insufficient surface contact between air molecules and AMD or NAMD water molecules for effective oxidation, high initial capital costs and high operating costs associated with replacement of chemicals, power consumption and maintenance.

### SUMMARY OF THE INVENTION

Accordingly, the present invention is directed to a method for treating AMD or NAMD waters containing heavy metals in solution with an iron oxide sludge generated from oxidation and precipitation of the heavy metals during the AMD or NAMD water treatment process, substantially obviating one or more problems due to limitations and disadvantages of the related art.

As previously mentioned, conventional systems of AMD and NAMD water treatment require relatively large surface areas for proper oxidation and sedimentation. As of this date, iron reduction rates of 10 to 40 grams per square meter of sedimentation basin surface area per day are typical of conventional Passive methods of AMD water treatment. Iron reduction rates of 500 to 800 grams per square meter of sedimentation basin surface area per day are typical of Active methods, depending on the degree of utilization of costly chemicals containing alkaline enhancing materials and flocculants.

Use of the present invention, when used in treating AMD or NAMD water with a pH of between 5.0 and 10.0, achieves iron reduction rates up to and in excess of 1,300 grams per day per square meter of sedimentation pond, basin or tank surface area, without the addition of chemicals The present invention accomplishes this with the use of relatively inexpensive-to-operate pumps and conduits for recovery and recirculation of precipitated iron oxide sludge as compared to the use of relatively expensive alkaline enhancing chemicals and precipitation enhancing flocculants normally used to accelerate the precipitation of heavy metals in solution in conventional Active treatment methods. The precipitated metal oxide sludge found in settlement ponds, basins or tanks in conventional Active AMD or NAMD water treatment systems is of poor to no commercial quality, often containing calcium sulfate, ferric hydroxide, ferrous hydroxide, aluminum hydroxide and manganese oxide with less than 1% solids, due to contamination from use of chemicals. As settling ponds, basins, or tanks become filled with precipitated sediment, this sludge requires expenditures for removal, transport and disposal. Use of the present invention creates precipitated sludge solids content up to and in excess of 20%. The precipitated sludge has higher concentrations of iron oxide that permit commercial marketing opportunities of iron oxide pigment with sufficient capital generated from these sales to recapture a significant portion of the total cost of treatment for AMD or NAMD water and eliminate a significant portion of the cost of disposal of precipitated sludge.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof.

It is to be understood that both the foregoing general description and the following detailed description of the present invention are exemplary and explanatory and are intended to provide further explanation of the invention as claimed.

### DETAILED DESCRIPTION OF THE PREFERRED EMBODIMENT

To achieve these objects and other advantages and in accordance with the purpose of the invention, as described in detail herein, a method for treating AMD or NAMD water containing heavy metals using an iron oxide catalyst, which is to treat AMD or NAMD water having a pH value between 5.0 and 10.0, containing one or more of the heavy metals of iron, manganese, magnesium, chromium and aluminum, includes: (a) pumping a portion of the precipitated iron oxide sludge from the treated AMD or NAMD water settlement basin(s) to an untreated AMD or NAMD water collection basin(s) and blending the precipitated iron oxide sludge in sufficient quantities with the untreated AMD or NAMD water to obtain an increase of total iron content in the blended iron oxide sludge/untreated AMD or NAMD water mixture; (b) transferring the blended iron oxide sludge/AMD or NAMD mixture to an aeration basin(s) or the upper portion of a settlement basin(s) whereby the blended water is sufficiently aerated with use of natural or mechanical means; (c) transferring to a settlement basin(s) of sufficient areal size (provided the settlement basin(s) is not part of the aeration basin(s)) to allow sufficient time to maximize precipitation of the catalyzed, oxidized heavy metals found in solution into iron oxide sludge; and (d) removing the balance of the iron oxide sludge either by use of pump and conduit to transfer sediment to a mechanical dryer; or by settlement system rotation to a second settling basin constructed for the purpose of allowing filled settlement basin(s) to atmospherically dry for subsequent excavation.

Although any amount of recirculated iron oxide sludge will accelerate the rate of oxidation and precipitation of iron found in solution, it has been determined, through field testing, that the total volume of precipitated iron oxide and/or iron hydroxide in the recirculated iron oxide sludge should be sufficient to allow a minimum of 2,000 milligrams per liter of total iron in the blended iron oxide sludge/untreated AMD or NAMD waters to achieve maximum efficiency of precipitation rate and achieve maximum volume removal of heavy metals from AMD or NAMD water.

Case 1—To obtain rate of flow of iron oxide sludge to be recirculated to a collection pond:

To obtain the maximum rate of acceleration of oxidation, the rate of flow of iron oxide sludge to be recirculated to a collection pond, basin or tank is determined as follows: (1) test for total iron content a representative sample of sludge being recirculated; (2) test for total iron content a representative sample of water taken from the untreated AMD or NAMD water to be treated; (3) test for rate of flow of untreated AMD or NAMD; using the mathematical
Rs=Rw(2,000 mg/Liter−Cw)/Cs−2000 mg/Liter Equation 1:
Where: Rs is the rate of flow of the recirculated iron oxide sludge in liters per minute

Rw is rate of flow of the untreated AMD or NAMD water in liters per minute

Cw is the total iron content of the untreated AMD or NAMD water in mg/Liter

Cs is the total iron content of the recirculated iron oxide sludge in mg/Liter

### EXAMPLE 1

Assume: The rate of flow of the untreated AMD or NAMD water (Rw) is measured to be 20,000 liters per minute. The recirculated iron oxide sludge has a total measured iron content (Cs) of 250,000 mg/Liter. The total iron content of the untreated AMD or NAMD water (Cw) is 30 mg/Liter. Using mathematical Equation 1:

Rs=20,000 liters/min (2,000 mg/Liter−30 mg/Liter)/250,000 mg/Liter−2,000 mg/Liter

Rs=158.9 liters/min.

For Example 1, to achieve maximum efficiency of treating AMD or NAMD water with recirculated iron oxide, converting from metric to British units, a minimum of 42 gallons per minute of iron oxide sludge containing 250,000 mg/Liter of precipitated iron should be recirculated to blend with 5,283 gallons per minute of untreated AMD or NAMD water containing 30 milligrams per liter of iron held in solution. A solids handling pump should be selected to efficiently pump a minimum of 42 gallons per minute of iron oxide sludge discharged to the collection pond, basin or tank for this application.

### EXAMPLE 2

Assume: The rate of flow of the untreated AMD or NAMD water (Rw) is measured to be 28,000 liters per minute. The recirculated iron oxide sludge has a total measured iron content (Cs) of 250,000 mg/Liter. The total iron content of the untreated AMD or NAMD water (Cw) is 70 mg/Liter. Using the mathematical formula above:

Rs=28,000 liters/min (2,000 mg/Liter−70 mg/Liter)/250,000 mg/Liter−2,000 mg/Liter

Rs=217.9 liters/min.

In Example 2, to achieve maximum efficiency of treating AMD or NAMD water with recirculated iron oxide, converting from metric to British units, a minimum of 57.6 gallons per minute of iron oxide sludge containing 250,000 mg/Liter of precipitated iron should be recirculated to blend with 7,397 gallons per minute of untreated AMD or NAMD water containing 70 milligrams per liter of iron held in solution. A solids handling pump should be selected to efficiently pump a minimum of 57 gallons per minute of recirculated iron oxide sludge discharged to the collection pond, basin or tank for this application.

The surface area of a settlement pond, basin or tank required for conventional means of treatment for AMD or NAMD water can be greatly diminished through the use of this invention due to the accelerated rate of oxidation and precipitation of the heavy metals found in solution in AMD or NAMD water. Accepted practices for Passive treatment of AMD or NAMD water requires construction of settlement pond(s), basin(s) or tank(s) of sufficient surface area to achieve precipitation of 10 grams to 40 grams of ferrous iron per day per square meter of settlement pond surface area. Accepted practices for Active treatment of AMD or NAMD water requires construction of settlement pond(s),basin(s) or tanks of sufficient surface area to achieve precipitation of 500 grams to 800 grams of ferrous iron per day per square meter of surface area. With use of this invention, oxidation and precipitation rates up to 1,300 grams of ferrous iron per day per square meter of surface area will be achieved.

Case 2—To determine areal design size of settlement pond:

Determining areal design size of settlement pond, basin or tank for a Passive or Active AMD or NAMD water treatment system is accomplished through use of mathematical
As=Rw×Cw/IRR Equation 2:
Where: As is the surface area of settlement pond, basin or tank

Rw is rate of flow of the untreated AMD or NAMD water in liters per minute

Cw is the total iron content of the untreated AMD or NAMD water in mg per liter

IRR is the iron removal rate in grams per day per square meter

### EXAMPLE 3

Passive System

Assume: The rate of flow of the untreated AMD or NAMD water (Rw) in a Passive system is measured to be 1,800 liters per minute. The total iron content of the untreated AMD or NAMD water (Cw) is 70 mg/Liter. The iron removal rate for a conventional Passive system is 20 grams/day/square meter. Using the mathematical Equation 2:

As=(1,800 L/min)(70 mg/L)(24 hrs/day)(60 min/hr)/(20 gms/day/sq. M)(1,000 mg/gm)

As=9,072 square meters=97,650 square feet=2.24 acres

Multiplying by a safety factor of 2 for unanticipated increase in volume of untreated AMD or NAMD water flows, the surface area required for a settling pond designed for Passive treatment would be 4.48 acres for treatment of an AMD or NAMD water flow of 475 gallons (1,800 liters) per minute. In geographical treatment areas where acreage to be dedicated for settling ponds is limited, by initiating this invention, the surface area can theoretically be reduced from 4.48 acres (195,149 square feet) to 0.0689 acres (3,002 square feet). This calculation was based upon an iron removal rate of 1,300 grams per day per square meter with use of this invention as compared to 20 grams per day per square meter with a conventional Passive system. In some situations, capital cost of land plus income lost from use of said land for Passive treatment is many times greater than capital cost of equipment and daily costs for operating said equipment required for this invention. In these situations it would be economically advantageous to convert a Passive system to a limited Active system.

### EXAMPLE 4

Active System

Assume: The rate of flow of the untreated AMD or NAMD water (Rw) in an Active system is measured to be 28,000 liters per minute. The total iron content of the untreated AMD or NAMD water (Cw) is 70 mg/Liter. The iron removal rate for a conventional Active system is 650 grams/day/square meter. Using the mathematical Equation 2:

As=(28,000 L/min)(70 mg/L)(24 hrs/day)(60 min/hr)/(650 gms/day/sq.M)(1,000 mg/gm)

As=4,342 square meters=46,737 square feet=1.07 acres

Multiplying by a safety factor of 2 for unanticipated increase in volume of untreated AMD or NAMD water flows, the surface area required for a settling pond designed for Active treatment would be 2.14 acres for treatment of an AMD or NAMD water flow of 7,397 gallons (28,000 liters) per minute. By initiating this invention, the surface area can theoretically be reduced from 2.14 acres (93,474 square feet) to 1.07 acres (46,737 square feet), while at the same time, eliminating the ongoing use of expensive chemicals. This calculation was based upon an iron removal rate of 1,300 grams per day per square meter with use of this invention as compared to 650 grams per day per square meter with a conventional Active system .

Case 3—To determine estimated value of annual volume of iron oxide pigment recovered:

Determination of the annual estimated value of iron oxide pigment recovered from treatment of AMD or NAMD water is accomplished through use of mathematical

$1O=Rw×Cw×P×525,600/907,184,740

Where: $1O is the estimated value of the iron oxide pigment recovered

Rw is rate of flow of the untreated AMD or NAMD water in liters per minute

Cw is the total iron content of the untreated AMD or NAMD water in mg per liter

P is the average price in US dollars received per short ton iron oxide pigment

525,600 is the conversion factor from minutes to years

907,184,740 is the conversion factor from milligrams to short tons

### EXAMPLE 5

Active System

Assume: The rate of flow of the untreated AMD or NAMD water (Rw) in an Active system is measured to be 28,000 liters per minute. The total iron content of the untreated AMD or NAMD water (Cw) is 70 mg/Liter.

$1O=28,000 L/min×70 mg/L×$200/ton×525,600 min/yr/907,184,740 mg/ton

$1O=$227,115

Since iron oxide precipitated through use of the invention is not contaminated with chemicals utilized by conventional active treatment systems, the iron oxide can be recovered and marketed as natural iron oxide pigment. The above Example 5 has demonstrated that the estimated annual value of the uncontaminated iron oxide pigment recovered through use of the invention is $227,115

While preferred embodiments of the invention have been described in detail herein, it will be appreciated by those skilled in the art that various modifications and alternatives to the preferred embodiments may be developed in light of the overall knowledge learned from the disclosure. Accordingly, the particular arrangements are illustrative only and are not limiting as to the scope of the invention which is to be given the full breadth of the appended claims and any and all equivalents thereof.

What I claim is:

1. A method for contributing to the successful treatment of acid mine drainage (AMD) or non-acid mine drainage (NAMD) water containing heavy metals in solution, specifically using recirculated iron oxide and/or iron oxide sludge, as a catalyst, at ambient temperatures, that has been precipitated in AMD or NAMD water treatment settlement pond(s), basin(s) or tank(s), accelerating the rate of oxidation and precipitation of heavy metals found in solution in AMD or NAMD water being treated, comprising the steps of:
placing a solids handling pump(s) with the suction side of the pump(s) connected to a conduit(s) with the intake side of the conduit(s) exposed to precipitated iron oxide sludge found in the bottom of AMD or NAMD treatment settling pond(s), basin(s) or tank(s),
connecting the discharge side of the above described solids handling pump(s) to the intake end of a conduit(s), pumping a portion of the precipitated iron oxide sludge to a mixing or blending pond(s), basin(s) or tank(s) located at the discharge end of the conduit(s),
discharging the pumped iron oxide sludge into a mixing or blending pond(s), basin(s) or tank(s) being used for inflow of AMD or NAMD waters containing heavy metals in solution, with the inflow of the AMD or NAMD being so directed to thoroughly blend with the outflow of iron oxide sludge, achieving a total iron content of the blended iron oxide sludge/AMD or NAMD waters mixture in excess of the untreated iron content of the AMD or NAMD waters mixture,
discharging the blended AMD or NAMD waters containing the recirculated iron oxide sludge to an aeration pond(s),basin(s) or tank(s) and/or settlement pond(s),basin(s) or tank(s), allowing acceleration of precipitation of heavy metals found in solution due to an increased rate of oxidation of heavy metals in solution in AMD or NAMD water, particularly iron, through adsorption due to solution particulate exposure to catalytic metal hydroxide particles found in the iron oxide sludge.
